(19) United States
(12) Patent Application Publication
(10) Pub. No.: US 2026/0145862 A1
(43) Pub. Date: May 28, 2026

(54) BOX FOR A HOT PLATE

(71) Applicant: Yosi Asban, Tzufim (IL)

(72) Inventor: Yosi Asban, Tzufim (IL)

(21) Appl. No.: 19/393,597

(22) Filed: Nov. 19, 2025

Related U.S. Application Data
(63) Continuation-in-part of application No. PCT/IL2025/050966, filed on Nov. 2, 2025.

(30) Foreign Application Priority Data
Nov. 25, 2024 (IL) 317366

(51) Int. Cl. B65D 81/38; B65D 81/34

(52) U.S. Cl. CPC B65D 81/3823; B65D 81/3407

(57) ABSTRACT

An insulating box system for a hot plate, comprising a non-thermally insulating frame and a cover with a non-thermally insulating inner layer, wherein the insulating box is configured not to contact a surface of the hot plate.

### RELATED APPLICATIONS

This application is a Continuation in Part of International patent application PCT/IL 2025/050966 filed on 2 Nov. 2025 which claims the benefit of priority of Israel Patent Application No. 317366 filed on 25 Nov. 2024, the contents of which are incorporated herein by reference in their entirety.

### FIELD AND BACKGROUND OF THE INVENTION

The present invention in some embodiments thereof relates to an insulating box system and, more particularly, but not exclusively, to an insulating box system for a hot plate.

Hot plates are conventionally used to heat and/or maintain the heat of a previously cooked food. However, they tend to be inefficient, with a great deal of heat being dissipated due to their open top. Additionally, moisture from the food can be lost making it dry, and may even burn the food on prolonged exposure.

Hot plates are commonly used to heat or maintain the heat of meals previously prepared for Shabbat, when cooking is prohibited. Several halachic rules need to be obeyed when insulating such hot plates, e.g., the pots cannot be completely wrapped in an insulating material, etc. Currently, many households additionally cover the hot plate with a towel or blanket for insulation, which can be a fire hazard.

Therefore, there is a need for a system and method to insulate hot plates which is efficient, low cost, safe and conforms to halachic requirements.

### SUMMARY OF THE INVENTION

According to an aspect of some embodiments of the invention, there is provided a box for a hot plate including: heat resistant partitions forming at least two walls and a top; and an bottom opening bottom into which fits a hot plate.

According to some embodiments of the invention, at least one of the heat resistant partitions includes a frame and a cover configured to attach to the frame.

According to some embodiments of the invention, the frame is made of a non-thermally insulating material.

According to some embodiments of the invention, the cover includes an inner layer including a non-thermally insulating material.

According to some embodiments of the invention, the frame includes multiple partitions.

According to some embodiments of the invention, the frame includes a top partition and two side partitions.

According to some embodiments of the invention, the frame includes a top partition, a back partition and two side partitions.

According to some embodiments of the invention, the partitions are constructed from vertically and horizontally cross-linked bars in a grid.

According to some embodiments of the invention, two of the partitions are connected together by a joint.

According to some embodiments of the invention, the two of the partitions rotate with respect to the joint.

According to some embodiments of the invention, a joint holds the two of the partitions distanced from each other at least 1 mm.

According to some embodiments of the invention, the box further includes a removable shelf.

According to some embodiments of the invention, a height of the removable shelf within the box is adjustable.

According to some embodiments of the invention, the cover is attached to the frame by multiple heat-proof connectors.

According to some embodiments of the invention, the cover includes multiple layers.

According to some embodiments of the invention, the cover includes an inner layer including a non-thermally insulating material and a fabric outer layer.

According to some embodiments of the invention, the cover includes an insulating intermediate layer sandwiched between the non-thermally insulating inner layer and the fabric outer layer.

According to some embodiments of the invention, the cover consists of a single piece.

According to some embodiments of the invention, the cover consists of multiple pieces.

According to some embodiments of the invention, the multiple pieces are interconnected by fasteners.

According to some embodiments of the invention, the box is open on one side.

According to some embodiments of the invention, the frame is open on one side and all sides of the box are covered by the cover.

According to some embodiments of the invention, the side of the cover which covers the open side of the frame is reversibly openable.

According to some embodiments of the invention, the box is foldable.

According to an aspect of some embodiments of the invention, there is provided a method of insulating pots on a hot plate, the method including: unfolding a plurality of partitions to form a box with an opening in a bottom thereof; placing the box over a hot plate with the hot plate protruding into the box through the opening in the bottom.

According to some embodiments of the invention, at least one partition of the plurality of partitions includes a frame and a cover, the method further including: attaching the cover to an exterior surface of the frame to form the at least one partition.

According to some embodiments of the invention, the cover includes an non-thermally insulating inner layer and wherein the attaching the cover includes attaching the cover to the exterior surface of the frame with a non-thermally insulating inner layer facing inwards.

According to some embodiments of the invention, the attaching the cover to the exterior surface of the frame is reversible.

According to some embodiments of the invention, the attaching the cover to the exterior surface of the frame is reversible.

According to some embodiments of the invention, the method further includes fastening multiple pieces of the cover together with fasteners.

According to some embodiments of the invention, the method further includes folding the box with the cover attached to the frame.

According to some embodiments of the invention, the folding includes rotating a first partition of the frame with respect to a second partition of the frame.

According to some embodiments of the invention, the first partition and the second partition are interconnected by a hinge.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-B: Schematic illustrations of cut away views of an exemplary insulating box in use, in accordance with some embodiments of the current invention.

FIGS. 2A-B: Schematic illustrations of perspective views of a partial frame, in accordance with an embodiment of the current invention.

FIGS. 3A-B: Schematic illustrations of a front and side view, respectively, of a back partition, in accordance with an embodiment of the current invention.

FIGS. 4A-B: Schematic illustrations of a front and side view, respectively, of a side partition, in accordance with an embodiment of the current invention

FIGS. 5A-C: Schematic illustrations of a front, side and perspective views, respectively, of a top partition, in accordance with an embodiment of the current invention.

FIGS. 6A-C: Schematic illustrations of a front, side and perspective views, respectively, of a removable shelf, in accordance with an embodiment of the current invention.

FIGS. 7A-B: Schematic illustrations of a side and perspective views, respectively, of an exemplary joint, in accordance with an embodiment of the current invention.

FIGS. 8A-D: Schematic illustrations of front and back views of an exemplary back cover, in accordance with an embodiment of the current invention.

FIGS. 9A-D: Schematic illustrations of front and back views of an exemplary side cover, in accordance with an embodiment of the current invention.

FIGS. 10A-B: Schematic illustrations of front and back views of an exemplary top cover, in accordance with an embodiment of the current invention.

FIG. 11: Block diagram illustrating an insulating box, in accordance with an embodiment of the current invention.

FIG. 12: Flow chart of a method of using an insulating box, in accordance with an embodiment of the current invention.

### DESCRIPTION OF SPECIFIC EMBODIMENTS OF THE INVENTION

The present invention in some embodiments thereof relates to an insulating box system and, more particularly, but not exclusively, to an insulating box system for a hot plate.

### Overview

The present invention in some embodiments thereof relates to an insulating box system and method is described and disclosed. Optionally, the insulating box system may be used to insulate a hot plate. Optionally, the box may be separate from the hot place. For example, the insulating box may include an opening on the bottom for placement over the hot plate. Optionally the entire bottom of the box may be open. Optionally, the insulating box may be an open bottom insulated box. Optionally, the insulating box may fit over a hot plate. Optionally, the insulating box may fit over a hot plate without contacting any of the surfaces and/or the sides of the hot plate.

According to some embodiments, the insulating box may comprise of a frame and/or a cover. Alternatively or additionally, the box may include a solid wall and/or a solid cover. Optionally, the box may be foldable. For example, the partitions may fold together and/or open to form the box. Alternatively or additionally, the cover may be removed from the frame and/or each may be folded separately. Optionally, the frame and/or cover may be dismantled when not in use and/or for storage. Alternatively or additionally, the entire box may be folded with the partitions intact (e.g., frame and cover together). Optionally, the insulating box may be compact when folded. Optionally, the insulating box may be portable. Optionally, the insulating box, and/or components thereof may be easy to clean.

According to some embodiments, the frame may include multiple partitions. Optionally, the partitions may be connected together to provide the frame of the insulating box. Optionally, the frame may include a top partition, and side partitions. Optionally, the frame may include a top partition, a back partition and side partitions. Optionally, the frame may be open on one side. Optionally, the frame may include a section which may be opened and/or closed, e.g., doors, flap, etc. to provide access to the hot plate. Optionally, the frame may include a section which may be opened and/or closed to facilitate access to the hot plate.

According to some embodiments, the partitions may be connected by one or more connectors joints. Optionally, the joints may be configured to facilitate rotation about the joint. Optionally, the joint may be hinged. Optionally, the joints may be located along the edges of the partitions. Optionally, the joints may be evenly spaced along the edges of the partitions. Optionally, the partitions may include a mechanism to lock them together and/or to prevent rotation and/or to assist in stabilization of the frame.

According to some embodiments, the frame may be sufficiently sturdy to stand without additional support. Optionally, the frame may be sufficiently sturdy to support the weight of one or more pots. Optionally, the frame may be configured to minimize contact of a pot with the frame. Optionally, even if a pot should contact the frame, the system is configured such that the pot would contact non-thermally insulating material and/or the frame without contacting the thermally insulating cover and/or the flexible cover.

According to some embodiments, partitions may comprise the sides and/or top of the insulating box. Optionally, the insulating box may be open at the bottom. Optionally, the insulating box may be open on one or more sides. Optionally, the insulating box may be open on at least one side to facilitate access to the hot plate. Optionally, the insulating box may include a section which may be opened and/or closed, e.g., doors, flap, etc. to provide access to the hot plate. Optionally, the insulating box may include a section which may be opened and/or closed to facilitate access to the hot plate. Optionally, the insulating box may be open at the base. Optionally, the open base may facilitate placement of the insulating box over the hot plate.

According to some embodiments, the frame may be constructed from cross-linked horizontal and vertical bars. Optionally, the cross-linked bars may form a grid and/or network. Optionally, the bars may have a diameter ranging between about 1 mm to about 3 mm, and/or between about 3 mm to about 5 mm, and/or between about 5 mm to about 7 mm. Optionally, the frame may be composed of a non-thermally insulating material. Optionally, the frame may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the frame, or part thereof, may be recyclable. Optionally, the frame, or part thereof, may be composed of recycled material.

According to some embodiments, the frame grid may be composed of regularly spaced bars. Optionally, the bars may be spaced apart to form a network. Optionally, the cross-linked cross bars may be closely spaced. Optionally, the distance between the bars may range between about 3 cm to about 5 cm, and/or between about 5 cm to about 7 cm, and/or between about 7 cm to about 10 cm. Optionally, the width and length of the grid squares may be similar. Optionally, the width and length of the grid squares may be different.

According to some embodiments, the frame may include a removable shelf. Optionally, the height of the removable shelf within the insulating box may be adjustable. Optionally, the removable shelf may be reversibly attached to the frame, e.g., by hooks, clips, etc. Optionally, the removable shelf may not protrude laterally from the frame. Optionally, the removable shelf may be configured not to protrude laterally from the frame to prevent contact with the cover. Optionally, the removable shelf may be constructed from cross-linked bars. Optionally, the bars may be composed of a non-thermally insulating material. Optionally, the frame may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the removable shelf may contact the base of a pot. Optionally, since the removable shelf is composed of non-thermally insulating material, the base of the pot may only contact non-thermally insulating material and may therefore not break halachic law. Optionally, the removable shelf may be sufficiently sturdy to support the weight of one or more pots. Optionally, the removable shelf may be configured to minimize contact of a pot with the frame. Optionally, the removable shelf may assist in stabilizing the frame.

According to some embodiments, the insulating box may include a cover. Optionally, the cover may be open at the bottom. Optionally, the cover may be configured to fit over the frame. Optionally, the cover may be configured to fit over the exterior of the frame. Optionally, the cover may be configured to fit over all and/or part of the exterior of the frame. Optionally, the cover may be configured to fit over the top and/or sides of the exterior of the frame. Optionally, the cover may be open at the bottom. Optionally, the cover may be open on at least one side to facilitate access to the hot plate. Optionally, the cover may include a section which may be opened and/or closed, e.g., doors, flap, etc. to provide access to the hot plate.

According to some embodiments, the cover may be configured to attach to the exterior of the frame by a connector, e.g., clips, elasticated corners, elasticated edges, Velcro, ties, hook and eye, buttons, snaps, clasps, holes, rings, hooks, carbineers, adhesive, screws, or any combination thereof. Optionally, the connector may be heat-proof. Optionally, the connectors may be heat-resistant. Optionally, the cover may be reversibly attached to the exterior of the frame. Optionally, the cover may be permanently attached to the exterior of the frame.

According to some embodiments, the cover may comprise a single piece, Optionally, the cover may comprise multiple pieces. In some embodiments, multiple pieces of the cover may be reversibly linked together. Optionally, the cover pieces may be linked together and/or connected to the frame by one or more fasteners. Optionally, the fasteners may be selected from Velcro, zips, buttons, clips, hook and eye, snaps, clasps, ties, holes, rings, hooks, carbineers, or any combination thereof. Optionally, the cover, and/or part thereof may be flexible and/or foldable. Optionally, the cover may be replaceable.

According to some embodiments, the cover may be constructed from multiple layers. Optionally, the inner layer, closest to the frame, may be constructed from a non-thermally insulating material, e.g., aluminum foil, alloy foil, etc. Additionally or alternatively, the inner layer may be less flexible than the outer layer (e.g., made of thick foil). Optionally, the inner surface of the cover may be coated with a non-thermally insulating layer (e.g., a metal such as aluminum, etc.). Optionally, the cover may be configured such that should a pot contact the cover through the frame, the pot will only contact the non-thermally insulating inner layer. Optionally, the inner layer may be non-flammable. Optionally, the outer layer, furthest from the frame, may be constructed from a fabric, e.g., canvas, linen, cotton, polyester, wool, nomex, Kevlar, PBI Polybenzimidazole, Silicone, Aramid etc. Optionally, the cover may include an insulating layer sandwiched between the inner layer and/or the outer layer. Optionally, the insulating layer may be composed of am insulating material, e.g., cotton, stuffing, polyester, polyurethane, fabric blends, mineral wool, ceramic fiber, fiber glass, calcium silicate, foam insulation etc. Optionally, the cover may be easy to clean. Optionally, the cover may be washable.

According to some embodiments, the insulating box system may have a length ranging between about 25 cm to about 50 cm, and/or between about 50 cm to about 100 cm, and/or between about 100 cm to about 150 cm. According to some embodiments, the insulating box system may have a width ranging between about 15 cm to about 30 cm, and/or between about 30 cm to about 50 cm, and/or between about 50 cm to about 100 cm. According to some embodiments, the insulating box system may have a height ranging between about 15 cm to about 30 cm, and/or between about 30 cm to about 50 cm, and/or between about 50 cm to about 75 cm.

Some embodiments relate to an insulating box which conforms to halachic laws. For example, the insulating box may be an open bottom folding insulated box. The insulating box may fit over the hot plate such that it does not contact any of the sides or surfaces of the hot plate. In some embodiments, the insulating box may be composed of a non-thermally insulating frame. Optionally, the cover may have a non-thermally insulating inner layer. Optionally, the inner layer of the cover may be of a material with limited flexibility (e.g., to avoid possibility of it wrapping around a pot). For example, the inner layer of the cover may be Aluminum of thickness of The insulating box may be configured such that it does not contact a pot positioned on the hot plate. However, should a pot protrude from the hot plate and/or be moved during use such that it contacts the insulating box, then the post would only contact the non-thermally insulating frame and/or the non-thermally insulating inner layer of the cover may have a thickness between 1 to 10 microns and/or between 10 to 20 microns and/or between 20 to 100 microns and/or between 100 to 200 microns. For example, the inner layer may be made of Aluminum. In some embodiments, the inner layer may include a layer a polymer (e.g., polypropylene) in addition to and/or in place of the layer of Aluminum.

According to some embodiments, the frame of the insulating box may be unfolded from a storage configuration to a standing box configuration. Optionally, the frame may be assembled prior to use and/or disassembled for storage. Optionally, the frame may be folded for storage. Optionally, the partitions of frame may be locked in place. Optionally, the cover may be attached to the exterior of the frame, with the non-thermally insulating inner layer facing inwards. Optionally, the cover may be assembled prior to attachment to the frame. Optionally, the cover may be attached to the frame and/or other components of the cover piece by piece. In some embodiments, the frame is configured to fold with the cover attached thereto. For example, hinges connecting frame pieces may allow folding with space in between the elements, for example, a hinge may hold two frame elements distanced apart between 1 to 3 mm and/or between 3 to 10 mm. Optionally, both elements may rotate with respect to the hinge and/or just one element may respect to the hinge. For example, an element may rotate with respect to the hinge 90 degrees or more.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to the figures.

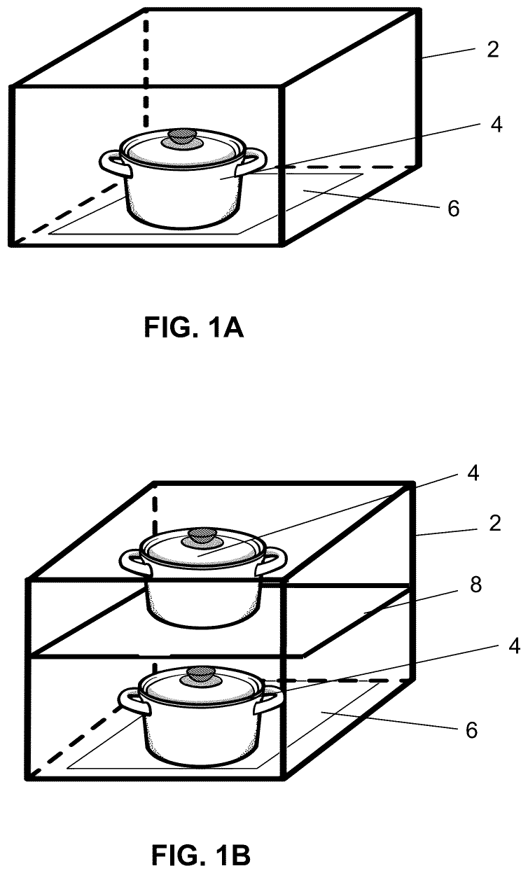

FIGS. 1A-B are schematic illustrations of cut away views of an exemplary insulating box in use, in accordance with some embodiments of the current invention. For example, an insulating box may include a frame 2 configured to fit over hot plate 6 and/or one or more pots 4 placed thereon. Optionally, the insulating box may be open at the bottom. Optionally, the insulating pot may include one or more removable shelves 8, which may be attached to frame 2. Optionally, the height of the removable shelves 8 within the insulating box may be adjustable.

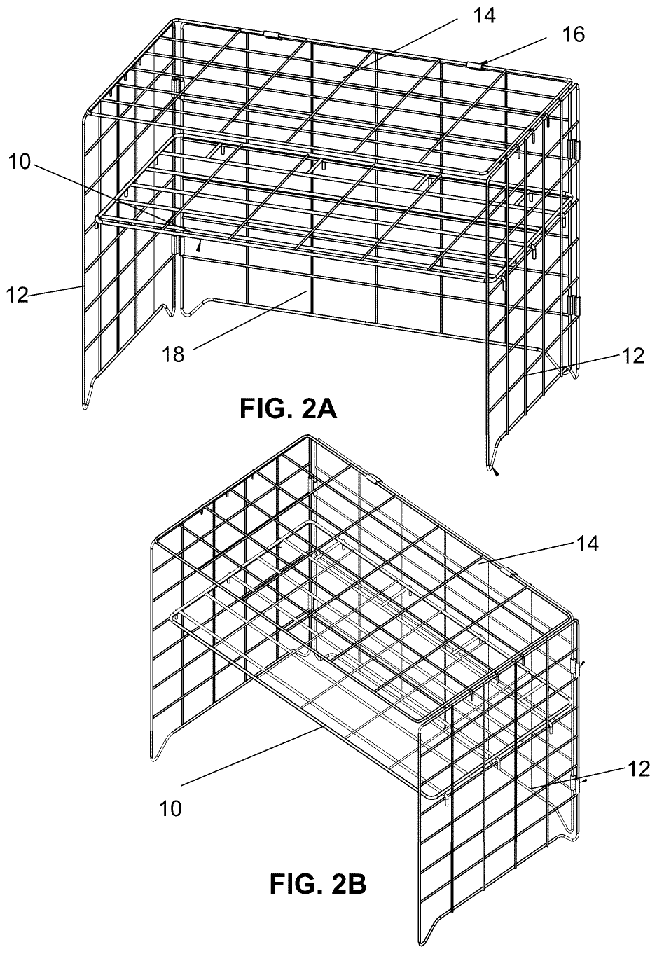

FIGS. 2A-B are schematic illustrations of perspective views of a partial frame, in accordance with an embodiment of the current invention. For example, the insulating box may include a frame. The frame may include multiple partitions, e.g., side partitions 12, a top partition 14, a back partition 18, etc. The partitions may be linked by multiple joints 16. Optionally, the joints 16 may be located along the edges of the partitions. Optionally, the joints 16 may be configured to facilitate rotation about the joints, e.g., the joints may facilitate free rotation thereabout to facilitate folding and unfolding of the frame. Optionally, the joints 16 may be spaced along the edges of the partitions. For example, the hinges may be spaced evenly along the edge and/or unevenly. Optionally, the partitions may include a mechanism to lock them together and/or to prevent rotation and/or to assist in stabilization of the frame. Optionally, the frame may be open-sided. Optionally, the frame may be open on one or more sides. Optionally, the frame may be open at the bottom in order to fit over the hot plate. Optionally, one or more removable shelves 10 may be attached to the frame, e.g., attached to the side partitions 12 and/or the back partition 18. The partitions and/or the removable shelf may be constructed from cross-linked horizontal and vertical bars.

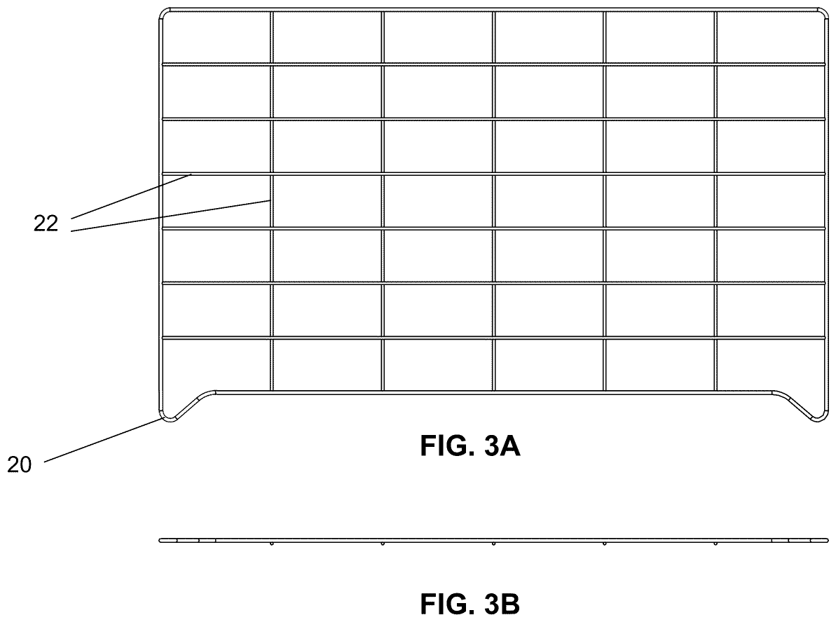

FIGS. 3A-B are schematic illustrations of a front and edge view, respectively, of a back partition, in accordance with an embodiment of the current invention. For example, the back partition may be constructed form cross-linked horizontal and vertical bars 22 to form a grid. Optionally, the bottom of the back partition may be extended to form legs 20. Optionally, the bars may have a diameter ranging between about 1 mm to about 3 mm, and/or between about 3 mm to about 5 mm, and/or between about 5 mm to about 7 mm. Optionally, the bars may be composed of a non-thermally insulating material. Optionally, the frame may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the bars may be spaced apart to form a network. Optionally, the cross-linked cross bars may be closely spaced. Optionally, the distance between the bars may range between about 3 cm to about 5 cm, and/or between about 5 cm to about 7 cm, and/or between about 7 cm to about 10 cm. Optionally, the width and length of the grid squares may be similar. Optionally, the width and length of the grid squares may be different.

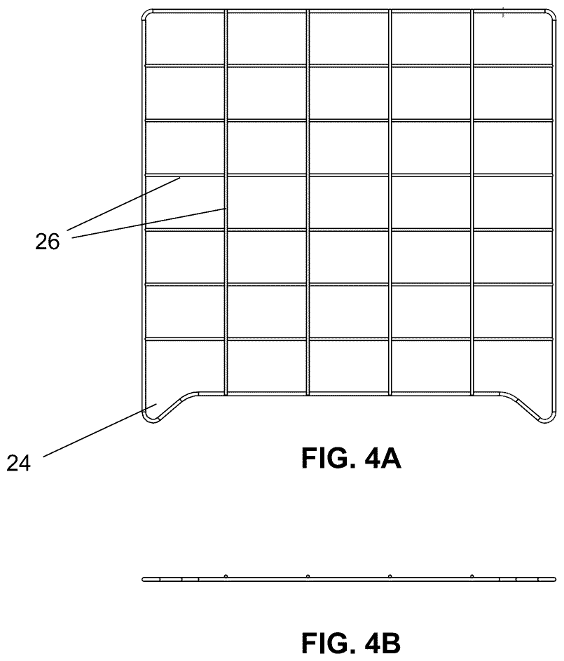

FIGS. 4A-B are schematic illustrations of a front and edge view, respectively, of a side partition, in accordance with an embodiment of the current invention for example, the side partitions may be constructed form cross-linked horizontal and vertical bars 26 to form a grid. Optionally, the bottom of the side partitions may be extended to form legs 24. Optionally, the bars may have a diameter ranging between about 1 mm to about 3 mm, and/or between about 3 mm to about 5 mm, and/or between about 5 mm to about 7 mm. Optionally, the bars may be composed of a non-thermally insulating material. Optionally, the frame may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the bars may be spaced apart to form a network. Optionally, the cross-linked cross bars may be closely spaced. Optionally, the distance between the bars may range between about 3 cm to about 5 cm, and/or between about 5 cm to about 7 cm, and/or between about 7 cm to about 10 cm. Optionally, the width and length of the grid squares may be similar. Optionally, the width and length of the grid squares may be different.

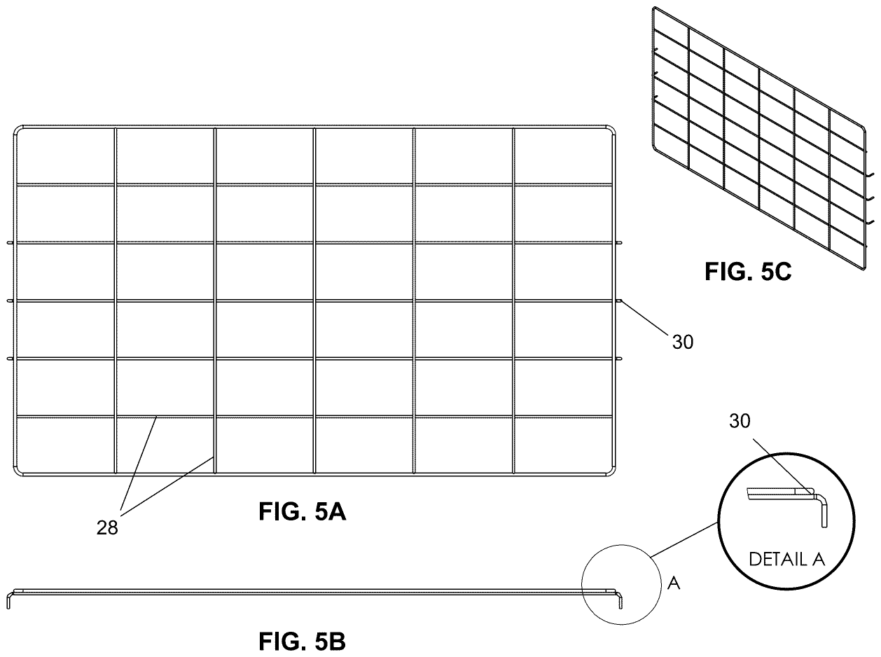

FIGS. 5A-C are schematic illustrations of a front, edge and perspective views, respectively, of a top partition, in accordance with an embodiment of the current invention. For example, the top partition may be constructed form cross-linked horizontal and vertical bars 28 to form a grid. Optionally, the one or more edges of the top partition may include hooks 30 (Detail A). The hooks may be spaced regularly along the edges of the top partition. Optionally, the hooks may be configured to attach and/or sit in attaching the top partition to the side partitions and/or the back partition. Optionally, the bars may have a diameter ranging between about 1 mm to about 3 mm, and/or between about 3 mm to about 5 mm, and/or between about 5 mm to about 7 mm. Optionally, the bars may be composed of a non-thermally insulating material. Optionally, the frame may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the bars may be spaced apart to form a network. Optionally, the cross-linked cross bars may be closely spaced. Optionally, the distance between the bars may range between about 3 cm to about 5 cm, and/or between about 5 cm to about 7 cm, and/or between about 7 cm to about 10 cm. Optionally, the width and length of the grid squares may be similar. Optionally, the width and length of the grid squares may be different.

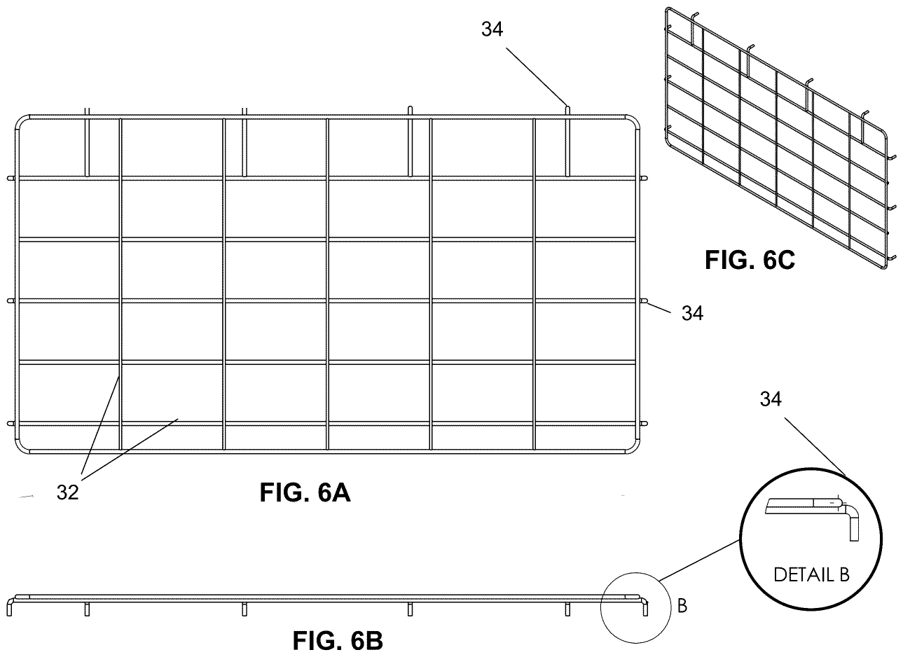

FIGS. 6A-C are schematic illustrations of a front, edge and perspective views, respectively, of a removable shelf, in accordance with an embodiment of the current invention. For example, the removable shelf may be constructed form cross-linked horizontal and vertical bars 32 to form a grid. Optionally, the one or more edges of the removable shelf may include hooks 34 (Detail B). The hooks may be spaced regularly along the edges of the removable shelf. Optionally, the hooks may be configured to attach and/or sit in attaching the removable shelf to the side partitions and/or the back partition. Optionally, the bars may have a diameter ranging between about 1 mm to about 3 mm, and/or between about 3 mm to about 5 mm, and/or between about 5 mm to about 7 mm. Optionally, the bars may be composed of a non-thermally insulating material. Optionally, the frame may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the bars may be spaced apart to form a network. Optionally, the cross-linked cross bars may be closely spaced. Optionally, the distance between the bars may range between about 3 cm to about 5 cm, and/or between about 5 cm to about 7 cm, and/or between about 7 cm to about 10 cm. Optionally, the width and length of the grid squares may be similar. Optionally, the width and length of the grid squares may be different.

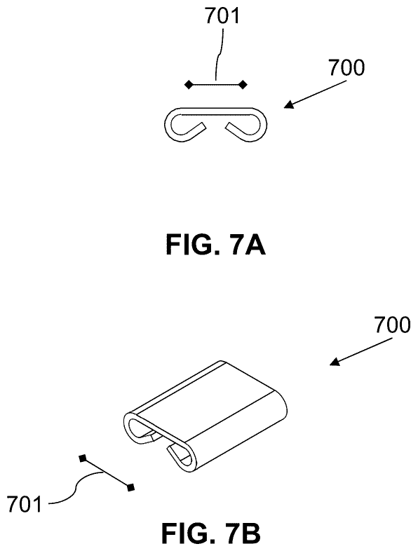

FIGS. 7A-B are schematic illustrations of an edge and perspective views, respectively, of an exemplary joint 700, in accordance with an embodiment of the current invention. For example, the partitions of the frame may be linked by one or more joints 700. Optionally, the joints 700 may be located along the edges of the partitions. Optionally, the joints 700 may be configured to facilitate rotation about the joints. For example, the joint 700 may hold two partitions. Optionally, one or both of the partitions may rotate with respect to the joint. Optionally, the partition may rotate less than 90, between 90 to 135 degrees and/or between 135 to 200 degrees or more with respect to the joint. Optionally, rotation of two partitions connected to the joint is independent. Rotation of the partitions with respect to the joint may facilitate folding and unfolding of the frame. Optionally the joint may hold two frame elements, separated by a space 701. For example, the space 701 may range between 1 to 3 mm and/or between 3-8 mm and/or between 8 to 20 mm. Optionally, the joints may be hinged. Optionally, the joints 16 may be evenly spaced along the edges of the partitions. Optionally, the joints may include a locking mechanism to lock the partitions together and/or prevent rotation about the joints. Optionally, the joints may be clipped onto the partitions prior to use. Optionally, the joints may be composed of a non-thermally insulating material. Optionally, the joints may be composed, at least in part, of a metal (e.g., aluminum, steel, carbon steel, cast iron, brass, etc.) and/or plastic (e.g., a thermoset plastic, nylon, polyurethane, polycarbonate, polyester, fiberglass reinforced plastic, etc.). Optionally, the joints, or part thereof, may be recyclable. Optionally, the joints, or part thereof, may be composed of recycled material.

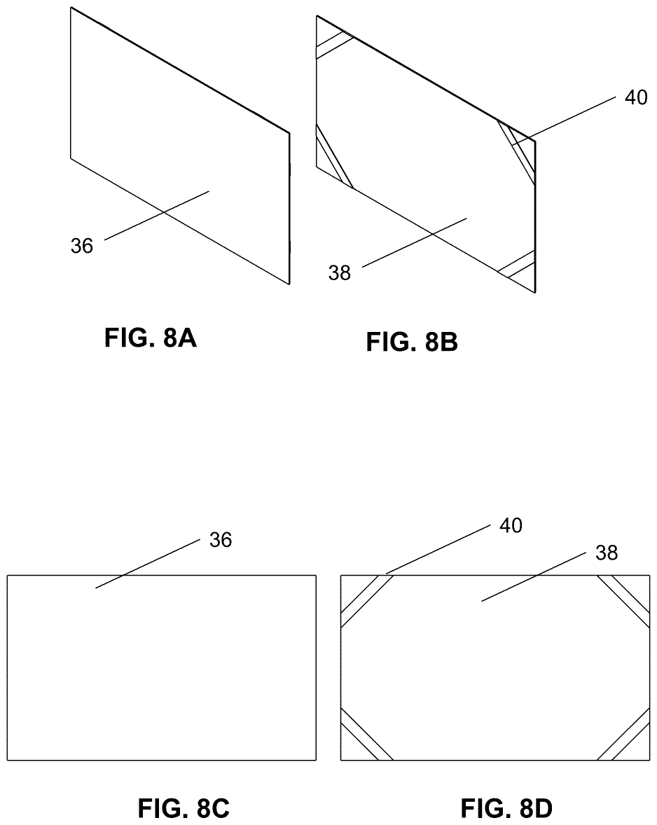

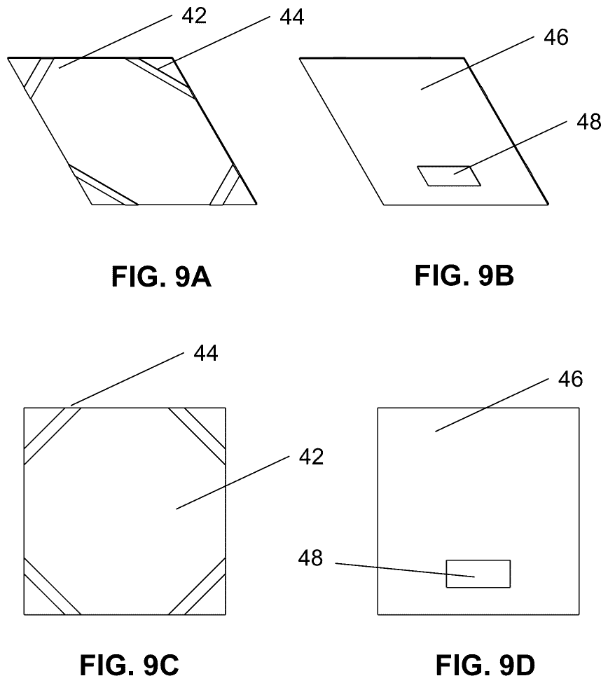

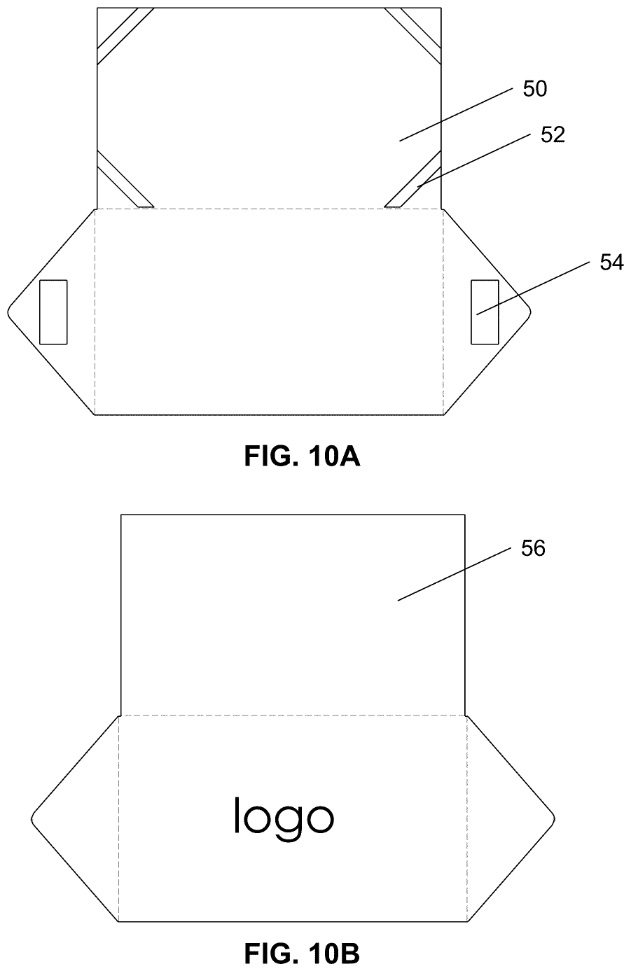

FIGS. 8A-D are schematic illustrations of front and back views of an exemplary back cover, in accordance with an embodiment of the current invention. FIGS. 9A-D are schematic illustrations of front and back views of an exemplary side cover, in accordance with an embodiment of the current invention. FIGS. 10A-B are schematic illustrations of front and back views of an exemplary top cover, in accordance with an embodiment of the current invention.

For example, the insulating box may include a cover. The cover may be configured to attach by a connector 40, 44, 52 to the exterior of the frame, e.g., clips, elasticated corners, elasticated edges, Velcro, ties, hook and eye, buttons, snaps, clasps, holes, rings, hooks, carbineers, adhesive, screws, or any combination thereof. Optionally, the connectors may be heat-proof. Optionally, the connectors may be heat-resistant. Optionally, the cover may be reversibly attached to the exterior of the frame. Optionally, the cover may be permanently attached to the exterior of the frame.

According to some embodiments, the cover may comprise a single piece, Optionally, the cover may comprise multiple pieces which may be reversibly linked together, e.g., back cover (e.g., FIGS. 8A-D), side covers (e.g., FIGS. 9A-D), top cover (e.g., 10A-B). Optionally, the cover may comprise multiple pieces which may be reversibly linked together to cover the frame. Optionally, the cover may comprise multiple pieces which may be reversibly linked together to form the top and sides of the insulating box. Optionally, the cover pieces may be linked together by one or more fasteners 48, 54. Optionally, the fasteners 48, 54 may be selected from Velcro, zips, buttons, clips, hook and eye, snaps, clasps, ties, holes, rings, hooks, carbineers, or any combination thereof. Optionally, the cover, and/or part thereof may be flexible and/or foldable. Optionally, the cover may be replaceable.

According to some embodiments, the cover may be constructed from multiple layers. Optionally, the inner layer 38, 42, 50, closest to the frame, may be constructed from a non-thermally insulating material, e.g., aluminum foil, alloy foil, etc. Optionally, the inner surface of the cover may be coated with a non-thermally insulating layer (e.g., a metal such as aluminum, etc.). Optionally, the cover may be configured such that should a pot contact the cover through the frame, the pot will only contact the non-thermally insulating inner layer 38, 42, 50 and/or surface. Optionally, the inner layer may be non-flammable. Optionally, the outer layer 36, 46, 56, furthest from the frame, may be constructed from a fabric, e.g., canvas, linen, cotton, polyester, etc. Optionally, the outer layer 36, 46, 56 may include a printed design and/or logo. Optionally, the cover may include an insulating layer (not shown) sandwiched between the inner layer and/or the outer layer. Optionally, the insulating layer may be composed of an insulating material, e.g., cotton, stuffing, polyester, polyurethane, fabric blends, etc. Optionally, the cover may be easy to clean. Optionally, the cover may be washable.

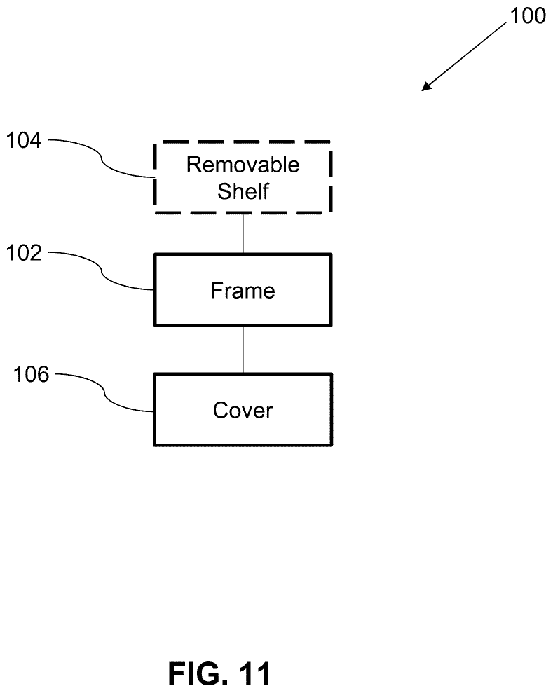

FIG. 11 is a block diagram illustrating an insulating box, in accordance with an embodiment of the current invention. For example, insulating box 100 may include a frame 102. In some embodiments there may be a removable shelf 104. For example, the shelf 104 may attach to the frame 102. In some embodiments, the box may include a cover 106. Optionally, the box is designed such that the shelf 104 does not contact the cover 106. Optionally, the insulating box may be open at the bottom. Optionally, the frame 102 may include a top partition, a back partition and two side partitions. Optionally, the frame 102 may be open sided. Optionally, the frame 102 may be composed of a non-thermally insulating material. Optionally, the cover 106 may be configured to fit over the frame. Optionally, the cover may not cover the bottom of the insulating box and/or frame. Optionally, the cover 106 may be attached externally to the frame. Optionally, the cover 106 may be composed of multiple layers. Optionally, the inner layer of the cover 106 may include and/or may be a non-thermally insulating material. Optionally, the outer layer of cover 106 may be a fabric. Optionally, the cover 106 may include an intermediate layer composed of an insulating material.

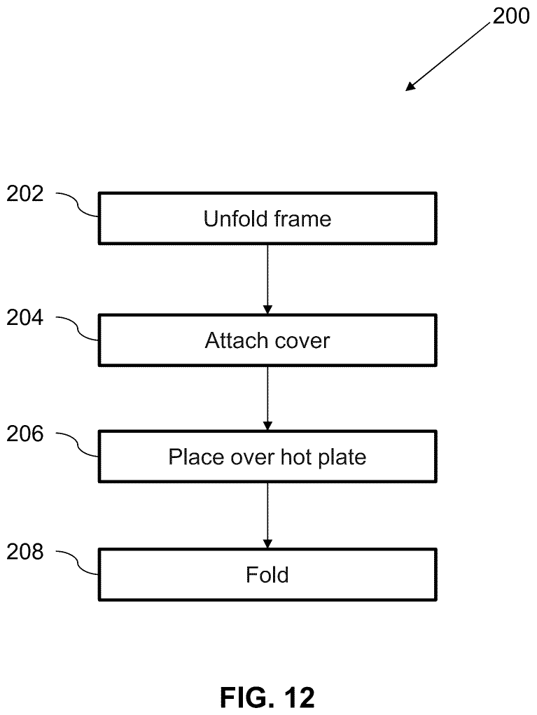

FIG. 12 is a flow chart of a method of using an insulating box, in accordance with an embodiment of the current invention. For example, in method 200, the frame may be unfolded 202. Optionally, the frame may be assembled prior to use. The cover may be attached 204 to the exterior of the frame with the non-thermally insulating layer facing inwards. The insulating box may be placed 206 over the hot plate and/or pots located thereon. In some embodiments, the box may be folded 208 with the cover attached to the frame. Alternatively or additionally, the cover may be separated from the frame and the frame may be folded 208 without the cover.

These embodiments are provided by way of example and are in no means intended to limit the scope of the invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

### General

It is expected that during the life of a patent maturing from this application many relevant technologies will be developed and the scope of the terms are intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein, the term “insulating” refers to thermally insulating.

As used herein, the term “non-insulating” refers to non-thermally insulating.

As used herein, the term “about” refers to ±10 %

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

As used herein, the terms “multiple” and “multi” are used interchangeably, and mean one or more, e.g., 1, 2, 3, 4, 5, 10, 20, etc.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A box for a hot plate comprising:
heat resistant partitions forming at least two walls and a top; and
a bottom opening bottom into which fits a hot plate.

2. The box of claim 1, wherein at least one of said heat resistant partitions includes a frame and a cover configured to attach to the frame.

3. The box of claim 2, wherein the frame is made of a non-thermally insulating material.

4. The box according to claim 2, wherein the frame includes multiple partitions.

5. The box according to claim 4, wherein the frame includes a top partition and two side partitions.

6. The box according to claim 4, wherein the frame includes a top partition, a back partition and two side partitions.

7. The box according to claim 4, wherein the partitions are constructed from vertically and horizontally cross-linked bars in a grid.

8. The box according to claim 4, wherein two of said partitions are connected together by a joint and the two of said partitions rotate with respect to the joint.

9. The box of claim 8, wherein a joint holds the two of the partitions distanced from each other at least 1 mm.

10. The box according to claim 2, wherein the cover includes an inner layer comprising a non-thermally insulating material and a fabric outer layer.

11. The box according to claim 10, wherein the cover includes an insulating intermediate layer sandwiched between the non-thermally insulating inner layer and the fabric outer layer.

12. The box according to claim 2 wherein the box is open on one side.

13. The box according to claim 2, wherein the frame is open on one side and all sides of the box are covered by the cover.

14. The box according to claim 13, wherein the side of the cover which covers the open side of the frame is reversibly openable.

15. The box according to claim 2, wherein the box is foldable.

16. A method of insulating pots on a hot plate, the method comprising:
unfolding a plurality of partitions to form a box with an opening in a bottom thereof;
placing the box over a hot plate with the hot plate protruding into the box through said opening in the bottom.

17. The method of claim 16, wherein at least one partition of said plurality of partitions includes a frame and a cover, the method further comprising:
attaching the cover to an exterior surface of the frame to form the at least one partition.

18. The method according to claim 17, wherein the cover includes a non-thermally insulating inner layer and wherein the attaching the cover includes attaching the cover to the exterior surface of the frame with a non-thermally insulating inner layer facing inwards.

19. The method according to claim 17, wherein the attaching the cover to the exterior surface of the frame is reversible.

20. The method according to claim 17, further comprising folding the box with the cover attached to the frame.
